(19) United States
(12) Patent Application Publication
(10) Pub. No.: US 2026/0124541 A1
(43) Pub. Date: May 7, 2026

(54) METHOD OF INCENTIVIZING THE VIEWING OF VIDEO ADVERTISEMENTS BY REWARDING VIEWERS WITH FREE CHANCES TO PLAY GAMES THAT AWARD VALUABLE PRIZES.

(71) Applicant: ALAN FRANK, Pittsburgh, PA (US)

(72) Inventor: ALAN FRANK, Pittsburgh, PA (US)

(21) Appl. No.: 18/939,489

(22) Filed: Nov. 6, 2024

(51) Int. Cl. A63F 13/61; A63F 13/52

(52) U.S. Cl. CPC A63F 13/61; A63F 13/52

(57) ABSTRACT

The current invention comprises adding hypertext links to a fixed quantity of video advertisements and motivating viewers to view the videos completely by rewarding the viewers with free chances to play instant online number guessing games that award big cash prizes 24/7/365. To obtain the rewards, viewers must click on the links that appear during the video-Ads'final seconds.

### BACKGROUND OF THE INVENTION

This application is being filed under 37 CFR 1.53(b) as a continuation-in-p and claims the benefit of a previous application namely, Ser. No. 17/346,317 that was filed Dec. 15, 2022 under 35 U.S.C. 120. This application repeats a substantial portion of said prior application and adds and claims additional disclosure not presented in the prior application.

The previous application and the current continuation-in-part application have the same inventor. The previous application. has not been abandoned nor granted nor is it a provisional application. The previous application of this continuation-in-part described an invention that addressed the desires and needs of retail merchants to attract users of computers, electronic tablets and cell phones to merchants'retail stores by operating free-play cash-prize online digit or image guessing games every 30-seconds of every day. This continuation-in-part describes an invention that focusses on upgrading the software that controls the digital screens in convenience stores and the digital screens embedded in fuel filling pumps and EV charging stations.

Advertisers will pay retail store proprietors $1.00 or more for each complete view of each video Ad by each viewer. If prizes are set at $1,000.00 for matching a four-digit number once every 10,000 plays, the “per-play” cost of prizes will be $ 0.10 per complete view of a video Ad. The net revenue will be $0.90 per complete view or per play.

The current invention will be especially effective in retail stores that have digital screens for ordering products and at fuel dispensing pumps in which digital screens are embedded.

### SUMMARY OF THE INVENTION

The Method described in this C.I.P. application will accomplish the following novel objectives for retail businesses:
1. Attract new customers to convenience stores by modernizing the software for their digital screens and for the digital screens embedded in their fuel dispensing pumps, and for the digital screens embedded in their EV charging stations. Said digital screens will function as “mini-billboards” that display video advertisements.
2. Make video advertisements more effective by increasing their 15% view through rate;
3. Generate revenue by charging fees for displaying video advertisements that get viewed completely;
4. Provide relief for the habituated, low revenue daily number players who waste personal funds paying state lotteries to satisfy their number betting habits.

In order to play the Colorball number guessing games of the current invention of this C.I.P. application, visitors to a retail business or a fuel pump that has been modernized by said invention must first tap a digital screen. Any tap will transfer the visitor to the Colorball website where the visitor can register with an email address and a password before viewing some video-Ads and then playing Colorball number guessing games.

When viewing the video-Ads, a visitor clicks the hypertext link that appears on each video-Ad during its final six seconds. Each click will enable the visitor to play one Colorball number guessing game. Initially, the limit will be five games.

The visitor then can transfer to the Colorball website “Play” page and create and submit a three-digit or four-digit number into play of the five Colorball number-guessing games that follow.

If a player's created number becomes matched by the winning number generated in next the five games, the player wins the cash prize then prevailing. Payments will be made in person by the proprietor. The size of the prize will vary as the business revenue varies.

The invention includes exactly 100 videos of ten differently numbered, differently colored balls bouncing around in a transparent mixing chamber for five seconds until one ball settles into the bottom of the chamber. Every 30 seconds, four videos of mixing balls are randomly selected from a pool of 100 videos and are displayed internationally at the “Play” page of website, www colorballnumbers.com.

The invention software includes 64 video Ads, each of which runs for 30-seconds, 90 times a day. Every 30 seconds, a different video-Ad will be randomly selected from a “gender-specific” pool of 32 video-Ads and displayed internationally to “gender-matching” viewers.

Each of the video-Ads will have a hypertext link appear during its final six seconds. By clicking on the link, or on one of the keys of a fuel pump or digital menu screen, the visitor will obtain a free chance to play a Colorball game and the advertiser will become obligated to pay the proprietor the prevailing “ad-displaying” fee.

If a viewer views the entire video-Ad but does not click the link, the advertiser does not pay anything. Each of the 32 video-Ads will be displayed 90 times per day to an international viewing audience. Players can create and submit their numbers into play during ball-mixing, but not during video-Ad displaying.

### DETAILED DESCRIPTION OF THE INVENTION

30-second video ads are one of the Internet's most effective advertising formats. Unfortunately, the “View-Through” rate of video ads has historically been less than 15%. The current invention was designed specifically to solve their “quick-click-out” problem and generate some sorely needed new revenue.

The current invention produces an extremely high “View-Through” rate of video-Ads. Advertisers pay a display fee only if a video-Ad is viewed completely, to its end. There will be dozens of complete views that are not followed by a “click of a button.” Advertisers will pay nothing. The Colorball advertising program provides advertisers with substantial effectiveness.

Each click of a Colorball enhanced video Ad causes a viewer's game-playing account to increase by “1” and enables advertisers to identify the source of each click and to count the quantity of clicks. The advertising revenue supports the games' prize structure.

The creation, production and use of recordings of digits being randomly generated to create the digits of winning numbers every 30-seconds is a major component of the novel method of operating online number guessing games of the current invention. The novel entertainment component of the invention is essential to incentivize complete viewing of the video advertisements that would otherwise be very boring.

The current invention addresses the desires and needs of convenience store businesses to generate revenue in a new manner, namely, by displaying video advertisements on the digital screens of food-ordering kiosks, fuel dispensing pumps and electronic vehicle charging stations by operating free-play cash-prize online number guessing games every 30 seconds of every day.

Convenience store businesses are constantly searching for innovative methods of marketing that will help retain and expand their customer bases. For maximum effectiveness, an internet marketing advertising program should operate automatically and continuously. It should be free and enjoyable and novel and should include a method of motivating business visitors to continue viewing the advertisements completely, from start to finish. Most importantly, since the online games of the current invention are free to play and winners receive cash prizes, it will stand alone in the retail business sector of digital advertising.

Live draw bouncing ball number guessing games have achieved a high level of popularity and respectability because of their high level of anxiety, joy and surprise. Historically, the digits on the balls were identified by human eyes as described in U.S. Pat. No. 4,601,471. The necessity of human intervention was almost eliminated by using bar-coded balls as described in U.S. Pat. No. 5,088,737. The necessity of human observation was finally eliminated by using differently colored balls as described in U.S. Pat. No. 9,751,002. With that invention, automatic live-draw generation of random numbers without requiring human eye identification finally became a reality.

The time span between number guessing games should be brief so that the players can enjoy prompt satisfaction. Accordingly, in the current invention the time span between number selecting games is set at 30-seconds. Every 24 hours, there are 2,880 different number guessing games that can be played internationally.

The current invention also addresses the issue of establishing the optimum prize amount. Advertising effectiveness and corresponding revenue will be the dominant factor. As they increase, so will the prize amount.

A preferred embodiment of the current invention includes a pool of one hundred videos. Each video shows ten differently colored, differently numbered balls being mixed in a transparent chamber for five seconds. One ball then randomly separates itself from the others and settles to the bottom.

Each ball is marked as follows:
The yellow-colored ball is marked with a “1”
The blue-colored ball is marked with a “2”
The red-colored ball is marked with a “3”
The purple-colored ball is marked with a “4”
The orange-colored ball is marked with a “5”
The green-colored ball is marked with a “6”
The white-colored ball is marked with a “7”
The black-colored ball is marked with an “8”
The tan-colored ball is marked with a “9”
The gray-colored ball is marked with a “0”

To create the pool, hundreds of videos were produced. The ten best looking videos of each number being randomly generated were selected for the pool.

Every 30 seconds of every day, 2,880 times a day, the software of the current invention randomly selects four recordings from the pool of 100. None of the four selected recordings are selected more than once. The four selected videos are displayed sequentially. The total time required to display the four recordings is about 25 seconds.

When producing the videos, a smartphone with a camera was mounted on a tripod stand facing the front of a mixing chamber that contained ten differently numbered, differently colored balls. The smartphone's audio/video mode was activated. An air blower mixed the balls for about ten seconds. A motor that was connected to the hinged bottom ramp of the mixing chamber began operating during the few seconds before the blower was stopped.

The digit on the bottom ball was announced and displayed above the mixing chamber after each ball settled. The blower was repeatedly re-started until several hundred brief videos of numbered balls being mixed were produced.

Each of the 100 videos in the pool was given an ID number ranging from 400 to 499 inclusive for filing purposes. The random number generating programming of the invention software currently selects four of the foregoing ID numbers every 30 seconds all day every day and commands the display of their corresponding videos sequentially. The digit marked on each bottom ball is displayed above the mixing chamber and announced.

Every 30 seconds of every day, 2,880 times a day, the software of the current invention randomly generates the identification numbers of four videos of digits being mixed until one ball separates itself from the others and settles to the bottom of the mixing chamber. Then the software causes the display of videos of each of the four digits, one at a time. None of the four videos-is selected twice in the same game. Software then displays the four videos sequentially.

If a player selects and creates a combination of four digits and submits them into play for the next five games, and if the randomly generated combination of four digits in any of the next five games match the combination of five digits that were submitted into play, the player will win a CA$H prize immediately.

A preferred embodiment of the current invention will enable a visitor to a retail business or a fuel pump that has been modernized with the current invention to play five Colorball games if he/she logs in, views five 30-second video ads, taps on the hypertext links that appear during the last six seconds of each video Ad, transfers to the “Play” page of the website where games are displayed and played, creates a three digit or four digit number, submits it into play, and then views the random generation of digits that will form the winning numbers of the next five games.

As an integral part of the current invention, dozens of 30-second video Ads have been copied and downloaded as they were displayed on TV or the Internet. Colorball technicians superimposed hypertext links on the video-Ads. When the current invention becomes activated in a large quantity of businesses, Colorball staffers will transmit the modified video-Ads to the advertisers and obtain their permission to display the video Ads 90 times every day. Advertisers will pay a price of $1.00 per complete view. All accounting will be fully transparent to advertisers.

By clicking on a hyperlink, the playing account of the clicking person will increase by “1”, and the paying account of the advertiser will increase by $1.00.

Players are permitted to select digits or images-during the ball-mixing segment of every minute, but not during display of advertisements.

If a player's submitted combination of digits becomes matched by any of the next randomly

I claim:

66. A method of incentivizing the complete viewing of video advertisements, said method comprising the giving of rewards to people who view video advertisements completely, from start to finish, said rewards comprising a plurality of free chances to play number-guessing games wherein winners receive substantial prize money.

67. The method described in claim 66 wherein the digits of the winning numbers of said games are visibly, audibly and randomly generated.

68. The method described in claim 66 wherein the digits of the winning numbers of said games are provided by the random selection and display of videos of differently numbered balls being mixed until one ball randomly separates itself from the others.

69. The method described in claim 66 also comprising the random display of videos of differently numbered bouncing balls randomly generating the digits of the winning numbers of said games by randomly selecting and displaying four of said videos each game.

70. The method described in claim 66 also comprising the production of a pool of videos of digits being randomly generated by differently numbered balls and the random selection and display of a plurality of said videos each of said games.

71. The method described in claim 66 also comprising means for increasing the quantity of said free chances each time a viewer of a video advertisement presses, clicks or taps special text during the final twenty percent of said video advertisement, said method also comprising means for increasing the payment obligation of the sponsors of said video advertisement each time said special text is pressed, clicked or tapped.

72. The method described in claim 66, also comprising the assembling of a fixed quantity of video advertisements and the continuous random selection and display of one of said video advertisements at a time.
